(19) United States
(12) Patent Application Publication
(10) Pub. No.: US 2009/0140600 A1
(43) Pub. Date: Jun. 4, 2009

(54) WINDING MODULE OF PERMANENT MAGNET ELECTRIC MACHINERY

(75) Inventors: Mi-Ching TSAI, Tainan (TW); Liang-Yi HSU, Makung City (TW); Shang-Hsun MAO, Tainan (TW); Chien-Chin HUANG, Tainan (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignees: METAL INDUSTRIES RESEARCH & DEVELOPMENT CENTRE, Kaohsiung (TW); NATIONAL CHENG KUNG UNIVERSITY, Tainan City (TW)

(21) Appl. No.: 12/255,166

(22) Filed: Oct. 21, 2008

(30) Foreign Application Priority Data
Oct. 22, 2007 (TW) 096139449
Oct. 20, 2008 (TW) 097140113

(51) Int. Cl. H02K 1/06; H02K 23/66; H02K 41/02

(52) U.S. Cl. 310/254; 310/68 B; 310/12

(57) ABSTRACT

A winding module of permanent magnet electric machinery is described, in which coils of an electric machinery winding and a sensing device are integrally arranged. The winding module includes a base, a plurality of electric machinery windings formed on the base, and a plurality of sensing devices formed at intervals on the base. The coils of the electric machinery winding and the sensing device are integrally formed on the base by using a technique for forming a printed circuit board, thereby improving the process yield rate and quality controllability, effectively reducing the volume of the electric machinery, thinning the structure, saving time and cost required for installing a position sensor, simplifying the process for fabricating the electric machinery, and preventing the position sensor from being affected by environment and temperature, so as to have a highly robust effect.

### CROSS-REFERENCE TO RELATED APPLICATION

This application claims the benefit of Taiwan Patent Application No. 096139449, filed on Oct. 22, 2007 and Taiwan Patent Application No. 0971400113, filed on Oct. 20, 2008, which are hereby incorporated by reference for all purposes as if fully set forth herein.

### BACKGROUND OF THE INVENTION

1. Field of Invention

The present invention relates to a winding module of permanent magnet electric machinery, and more particularly to a winding module of permanent magnet electric machinery, in which a plurality of winding coils of an electric machinery winding and a plurality of sensing coils of a sensing device are integrally formed on a base by using a technique for forming a printed circuit board or a similar technique.

2. Related Art

For conventional permanent magnet electric motors, no matter brush permanent magnet electric motors or brushless permanent magnet electric motors, most of the permanent magnet electric machinery adopts a radial air gap or a radial flux structure. As shown in FIG. 10, the permanent magnet electric machinery is formed by pivoting a stator portion 80 and a rotor portion 83, the stator portion 80 has a plurality of radiatingly formed radial magnetic iron cores 81, a coil 82 is wound on the magnetic iron core 81, a spindle 84 pivoted in the stator portion 80 is disposed in the rotor portion 83, a permanent magnet 85 located around the magnetic iron core 81 is disposed on an annular inner wall of the rotor portion 83, thereby forming the radial air gap structure. In the permanent magnet electric machinery with the radial air gap structure, the magnet and a large amount of magnetic material exist, such that the permanent magnet electric machinery has a magnetic cogging phenomenon and generates torque ripples, thereby resulting in an unsmooth operation or vibrations.

Referring to FIG. 11, a permanent magnet electric machinery with the axial air gap or the axial flux structure has a level board base 91, a stator portion 90 formed on the base 91, and a rotor portion 94 pivoted on the stator portion 90. A plurality of groups of winding coils 92 is disposed on the level board base 91, the rotor portion 94 is pivoted on the stator portion 90 through a spindle 95, a permanent magnet 96 is disposed on a bottom end surface of the rotor portion 94, and the axial air gap is formed between the permanent magnet 96 and the winding coils 92. In this type of permanent magnet electric machinery, the amount of the magnetic material is small, so the magnetic cogging phenomenon is not distinct. Further, this type of permanent magnet electric machinery has a flat structure, thus being applicable to special occasions having the requirement of being light, thin, short, and small.

The permanent magnet electric machinery must adopt copper wires, the permanent magnet electric machinery winding is realized by winding the copper wires so as to generate a flux linkage induction, thereby driving the rotor portion to operate. Most of wire sizes of the copper wires are standardized, so it cannot be randomly changed according to designing demands, and the quality of the copper wires is easily affected by the environment and the processing, such that the quality of the permanent magnet electric machinery is affected.

Referring to FIG. 12, a description on an operation principle of the conventional brushless permanent magnet electric machinery is given. Generation of a torque of the brushless permanent magnet electric machinery is closely related to each phase back-electromotive Force (EMF) of the electric machinery. When the back-EMF (e_{A}, e_{B}, and e_{C}) of each phase (A, B, and C) has the maximum value under a certain mechanical angle, it represents that a torque constant of each phase has the maximum value under the mechanical angle, and the torque is a product of a current (i_{A}, i_{B}, and i_{C}) and the phase back-EMF constant of each phase. A constant torque output may be obtained as long as a mechanical position of the rotor is detected by using an appropriate position sensing device, such as a Hall sensor, an exciting timing of the winding coil of each phase (A, B, and C) are determined by Hall sensor signals (X, Y, and Z), and then an appropriate exciting current is applied. However, the position sensor used by the common permanent magnet electric machinery is easily affected by the environment and the temperature, so as to result in position detecting error, thereby further affecting controlling performance of the permanent magnet electric machinery.

### SUMMARY OF THE INVENTION

The present invention is directed to provide a winding module of permanent magnet electric machinery. By using a technique for fabricating a printed circuit board and according to wiring of the technique, a permanent magnet electric machinery winding and a sensing device are respectively realized, and are integrally disposed in a circuit board, so as to generate a flux linkage induction on a rotor portion of the permanent magnet electric machinery, thereby driving the rotor portion. The printed circuit board technique is adopted, thereby improving the process yield rate and quality controllability, simplifying the process for fabricating the permanent magnet electric machinery, quickening the production, omitting additional sensing devices, and reducing the production cost. Further, the electric machinery winding and the sensing device are located in the same circuit board, thereby effectively reducing the volume, such that it is applicable to thin application products.

As embodied and broadly described herein, the winding module of the permanent magnet electric machinery of the present invention includes a base; an electric machinery winding, having a plurality of winding coils formed on the base; and a sensing device, having a plurality of sensing coils formed on the base.

The base of the present invention may be a printed circuit board with single layer or multilayer or a plurality of printed circuit boards, and the electric machinery winding and the sensing device may be formed on the same layer of the printed circuit board or respectively formed on the different layers.

When the electric machinery winding and the sensing device of the present invention are formed on the same layer, the sensing device is arranged in a distribution path of the electric machinery winding or beside the distribution path, the sensing coils are disposed on an intermediate region and a periphery of the winding coils, or are disposed at equal intervals among the winding coils, on an outer side or inner side of the winding coils. When the electric machinery winding and the sensing device are formed on the different layers, the arrangement manner of the sensing device and the electric machinery winding is not limited. However, the sensing coils must meet a certain angle position relation, so as to meet a phase conversion demand of the electric machinery. The relation is that the sensing coils are spaced from one another by an electric angle of 2π/n+2 kπ, n is a phase number, and k is a random integer.

The base, the electric machinery winding, and the sensing device of the winding module of the electric machinery of the present invention may form a stator portion or a rotor portion of the electric machinery, and the type of the electric machinery may be a rotating rotor type or a linear rotor type.

Through the design, the electric machinery winding and the sensing device are integrally designed, thereby effectively reducing the volume of the electric machinery, thinning the structure of the permanent magnet electric machinery, saving time and cost required for installing a position sensor, simplifying the process for fabricating the electric machinery, and preventing the position sensor from being affected by environment and temperature, so as to have a highly robust effect.

### BRIEF DESCRIPTION OF THE DRAWINGS

The present invention will become more fully understood from the detailed description given herein below for illustration only, and thus are not limitative of the present invention, and wherein:

FIG. 1 is a three-dimensional exploded view of the present invention forming a stator portion of an axial brushless electric machinery stator portion according to an embodiment, a rotor portion, and an outer case;

FIG. 2 is a schematic outside view of an embodiment of the axial brushless electric machinery formed by the present invention, the rotor portion, and the outer case;

FIG. 3A is a schematic view of an intermediate type distribution with the same distribution path of a sensing device and an electric machinery winding according to an embodiment of the present invention;

FIG. 3B is a schematic view of a periphery type distribution with the same distribution path of the sensing device and the electric machinery winding according to an embodiment of the present invention;

FIG. 3C is a schematic view of an inner side type distribution with different distribution paths of the sensing device and the electric machinery winding according to an embodiment of the present invention;

FIG. 3D is a schematic view of an outer side type distribution with the different distribution paths of the sensing device and the electric machinery winding according to an embodiment of the present invention;

FIG. 4 is a schematic exploded view of an embodiment of the present invention in which the electric machinery winding and sensing coils are respectively located on different printed circuit boards;

FIG. 5 is a partial cross-sectional view of the present invention applied to an axial flux brushless permanent magnet electric machinery being a rotating rotor type;

FIG. 6 is a partial cross-sectional view of the present invention forming a multi-rotor portion permanent magnet electric machinery according to an embodiment of the present invention;

FIG. 7 is a schematic exploded view of the present invention forming a linear permanent magnet electric machinery according to an embodiment of the present invention;

FIG. 8 is a schematic outside view of the present invention forming the linear permanent magnet electric machinery according to the embodiment of the present invention;

FIG. 9 is a schematic exploded view of the present invention forming a linear excitation electric machinery according to an embodiment of the present invention;

FIG. 10 is a schematic view of a conventional radial winding electric machinery;

FIG. 11 is a schematic view of a conventional axial winding electric machinery; and

FIG. 12 is a schematic view of a description on an operation principle of a conventional brushless permanent magnet electric machinery.

### DETAILED DESCRIPTION OF THE INVENTION

A winding module of permanent magnet electric machinery of the present invention is mainly applied to an axial flux brushless permanent magnet electric machinery, which may be a permanent magnet electric machinery or an excitation electric machinery, and the permanent magnet electric machinery may be a rotating rotor type, a linear rotor type, a sandwiched structure, or a multi-rotor structure.

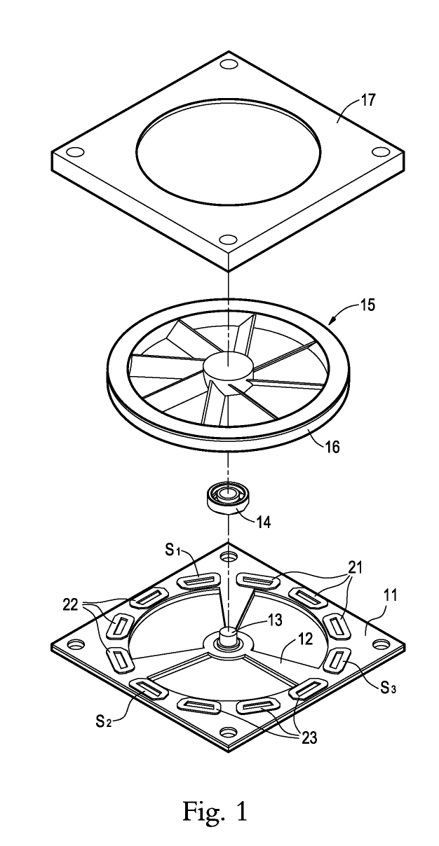

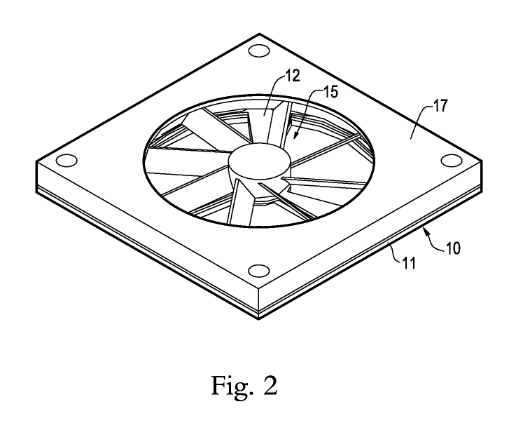

Referring to FIGS. 1 and 2, the present invention is applied to the axial flux brushless permanent magnet electric machinery being the rotating rotor type. The axial flux brushless permanent magnet electric machinery includes a stator portion 10 and a rotor portion 15. The rotor portion 15 is pivoted on the stator portion 10. The stator portion 10 has a plurality of ribs 12, and a spindle 13 is disposed in the ribs 12. A bearing 14 is disposed in the rotor portion 15, and the bearing 14 is disposed on the spindle 13. A permanent magnet 16 is disposed on the rotor portion 15, and an outer case 17 is disposed on the stator portion 10 for covering.

In an embodiment that the winding module of the permanent magnet electric machinery of the present invention forms the stator portion 10 of the permanent magnet electric machinery, the winding module includes a base 11; an electric machinery winding, having a plurality of winding coils formed on the base 11; a sensing device, having a plurality of sensing coils (S₁, S₂, and S₃) formed on the base 11, and arranged at intervals with the winding coils.

The winding coils of the electric machinery winding as shown in FIG. 1 are A-phase winding coils 21, B-phase winding coils 22, and C-phase winding coils 23 forming the three-phase windings, the winding coils may also form two-phase winding coils, four-phase winding coils, or winding coils with other number of phases. In the drawing, the three-phase windings are set as an example, but the present invention is not limited to the three-phase windings.

The base 11 is a printed circuit board, the electric machinery winding and the sensing device as shown in FIG. 1 are disposed on the same printed circuit board.

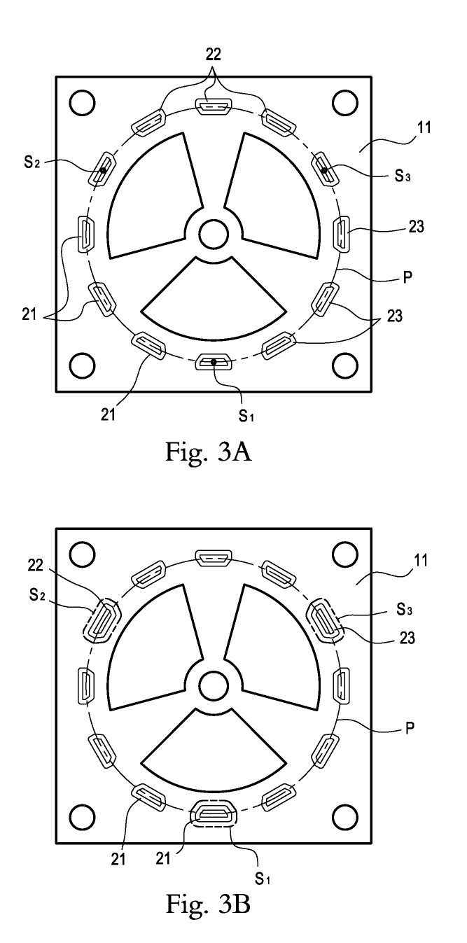

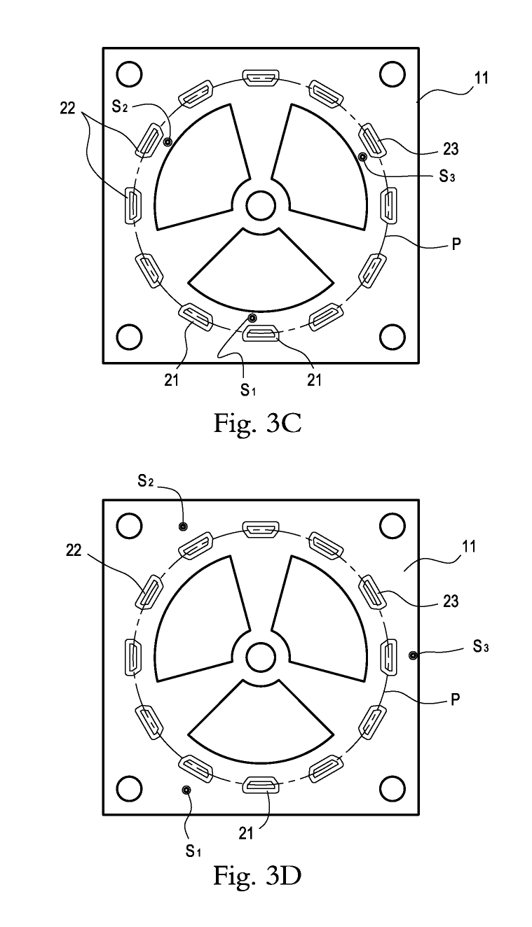

In the embodiment as shown in FIG. 1, the sensing device and the electric machinery winding disposed on the base 11 are arranged at intervals, and other arrangement aspects are also available. Referring to FIGS. 3A and 3B, a schematic view of an intermediate type distribution with the same distribution path of the sensing device and the electric machinery winding according to an embodiment of the present invention and a schematic view of a periphery type distribution with the same distribution path of the sensing device and the electric machinery winding according to an embodiment of the present invention are shown. In an embodiment that the sensing device and the electric machinery winding of the present invention are formed on the same printed circuit board, and the sensing device is disposed in a distribution path region P of the winding coils of the electric machinery winding, the sensing coils (S₁, S₂, and S₃) are located on an intermediate region (as shown in FIG. 3A) or a periphery (as shown in FIG. 3B) of the A-phase winding coils 21, the B-phase winding coils 22, and the C-phase winding coils 23. In addition, the sensing device may also be formed beside the distribution path region P of the A-phase winding coils 21, the B-phase winding coils 22, and the C-phase winding coils 23. Referring to FIGS. 3C and 3D, a schematic view of an inner side type distribution with different distribution paths of the sensing device and the electric machinery winding according to an embodiment of the present invention and a schematic view of an outer side type distribution with the different distribution paths of the sensing device and the electric machinery winding according to an embodiment of the present invention are shown. In the implementing aspects, the sensing coils (S₁, S₂, and S₃) are arranged on the inner side (as shown in FIG. 3C) or the outer side (as shown in FIG. 3D) of the distribution path region P of the A-phase winding coils 21, the B-phase winding coils 22, and the C-phase winding coils 23.

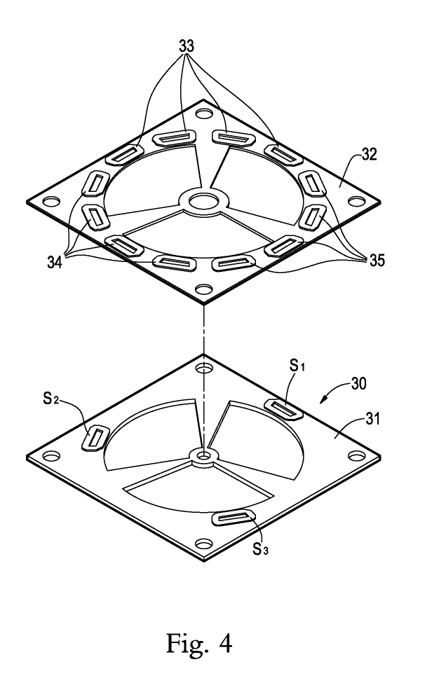

Referring to FIG. 4, the winding module serves as a stator portion 30 of the axial flux brushless permanent magnet electric machinery being the rotating rotor type. The base includes a first substrate 31 and a second substrate 32, and the first substrate 31 and the second substrate 32 are printed circuit boards. The electric machinery winding has a plurality of winding coils formed on the second substrate 32. The sensing device has a plurality of sensing coils (S₁, S₂, and S₃) formed on the first substrate 31. The first substrate 31 and the second substrate 32 are laminated, such that the electric machinery winding and the sensing device are disposed on the different printed circuit boards. Referring to FIG. 4, a structure of two substrates is shown, and the base may also be three substrates, four substrates, and other number of substrates which is more than two. The winding coils of the electric machinery winding and the sensing coils of the sensing device may be respectively formed on the different substrates.

In addition to the application that the plurality of substrates are adopted, and the winding coils of the electric machinery winding and the sensing coils of the sensing device are respectively formed on the different substrates. A multi-layer type printed circuit board may be further adopted, that is, one printed circuit board (substrate) has a plurality of layers of electric lines, and the winding coils of the electric machinery winding and the sensing coils of the sensing device are respectively formed on different layers of electric lines of the multi-layer type printed circuit board.

The winding coils of the electric machinery winding as shown in FIG. 4 are A-phase winding coils 33, B-phase winding coils 34, and C-phase winding coils 35 forming the three-phase windings, and the winding coils may also form one-phase winding coils, two-phase winding coils, four-phase winding coils, or winding coils with other number of phases.

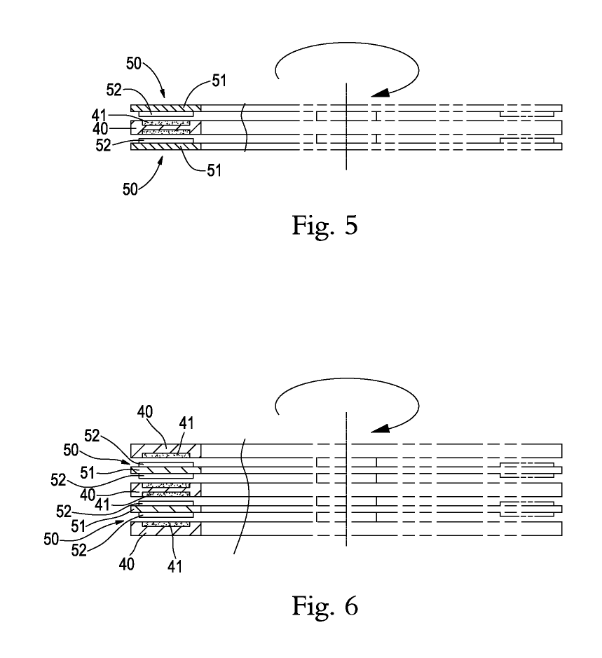

Referring to FIG. 5, the present invention is applied to the axial flux brushless permanent magnet electric machinery being the rotating rotor type. The axial flux brushless permanent magnet electric machinery includes a rotor portion 40 and two stator portions 50, the rotor portion 40 is pivoted between the two stator portions 50 to form the sandwiched structure, and a permanent magnet 41 is respectively disposed on upper and lower side peripheries of the rotor portion 40.

In the embodiment as shown in FIG. 5, in which the winding module of the permanent magnet electric machinery forms a stator portion 50 of the axial flux brushless permanent magnet electric machinery, the winding module includes a base 51 that is a printed circuit board. A plurality of winding coils 52 of an electric machinery winding and a plurality of sensing coils of a sensing device are formed on the periphery of the base 51, so as to form an axial air gap with the permanent magnet 41. The winding coils 52 of the electric machinery winding and the sensing coils are surroundingly arranged at intervals.

Referring to FIG. 6, it is a partial cross-sectional view of the present invention forming a multi-rotor portion permanent magnet electric machinery according to an embodiment of the present invention. The axial flux brushless permanent magnet electric machinery includes a plurality of rotor portions 40 and a plurality of stator portions 50. The rotor portions 40 are pivoted in the stator portions 50, the plurality of stator portions 50 and the plurality of rotor portions 40 are arranged at intervals to form a multi-rotor structure, and the permanent magnet 41 is respectively disposed on upper and lower side peripheries of the rotor portions 40.

The winding module of the permanent magnet electric machinery as shown in FIG. 6 forms the stator portion 50 of the axial flux brushless permanent magnet electric machinery and includes a base 51 that is a printed circuit board. A plurality of winding coils 52 of an electric machinery winding and a plurality of sensing coils of a sensing device are formed on the periphery of the base 51, so as to form an axial air gap with the permanent magnet 41, in which the winding coils 52 and the sensing coils are surroundingly arranged at intervals.

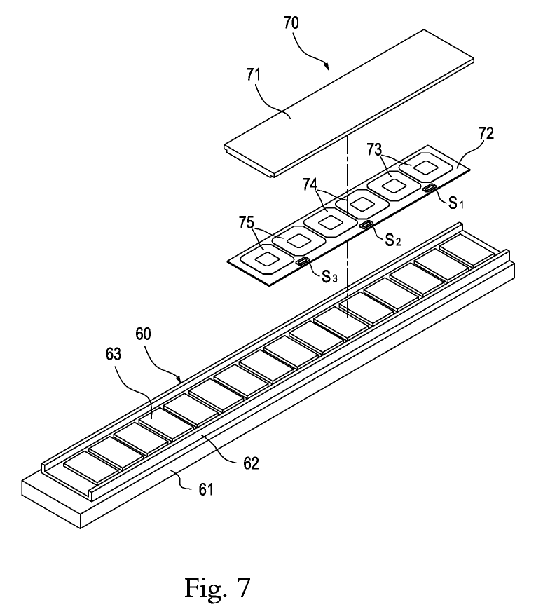

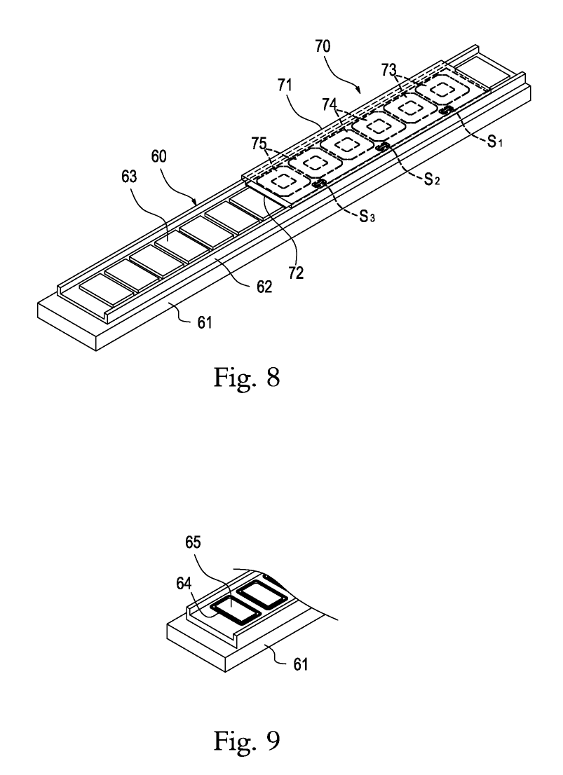

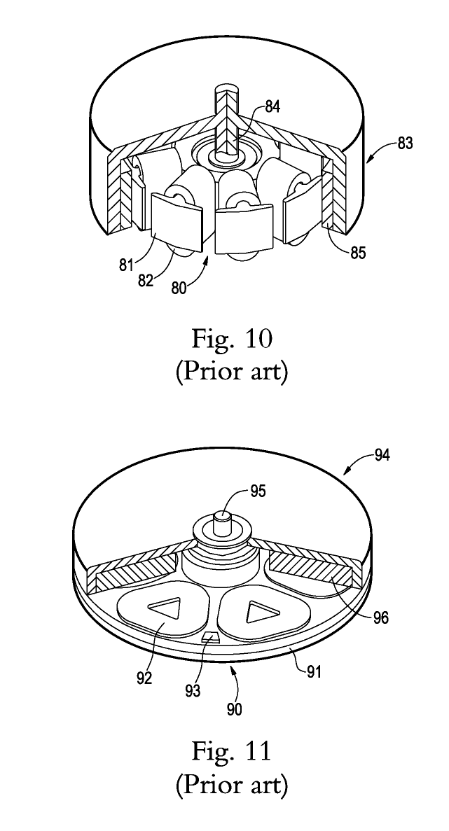

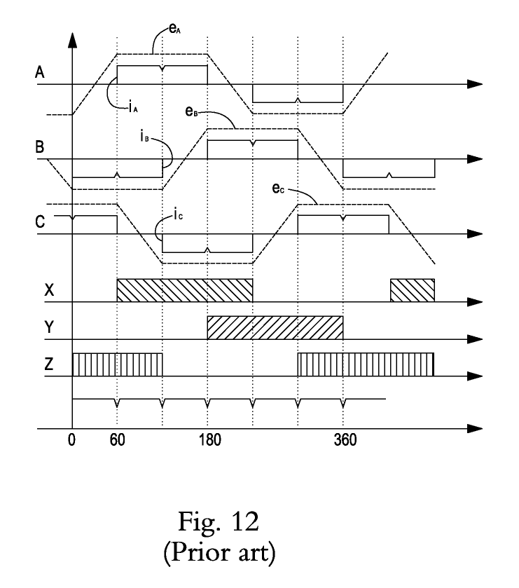

Referring to FIGS. 7 and 8, a schematic exploded view and a schematic outside view of the present invention applied to the brushless electric machinery being the linear rotor type according to an embodiment of the present invention are shown. The brushless electric machinery includes a stator portion 60 and a rotor portion 70, in the embodiment as shown in FIGS. 7 and 8, the stator portion 60 has a stator support 61, a rail 62 disposed on the stator support 61, and a plurality of permanent magnets 63 disposed adjacently side by side, and the rotor portion 70 has a rotor support 71.

In the embodiment, the winding module of the permanent magnet electric machinery of the present invention forming the rotor portion 70 of the linear rotor type permanent magnet electric machinery is disposed on a bottom end of the rotor support 71. The winding module includes a base 72, disposed on a bottom end of the rotor support 71; an electric machinery winding, having a plurality of winding coils formed on the base 72; and a sensing device, having a plurality of sensing coils S₁, S₂, and S₃ formed on the base 72.

The winding coils of the electric machinery winding as shown in FIG. 7 are A-phase winding coils 73, B-phase winding coils 74, and C-phase winding coils 75 forming the three-phase windings, the winding coils may also form two-phase winding coils, four-phase winding coils, or winding coils with other number of phases. In the drawing, the three-phase windings are set as an example, but the present invention is not limited to the three-phase windings. The phase winding coils (73, 74, and 75) of the electric machinery winding and the sensing coils (S₁, S₂, and S₃) are linearly arranged at intervals.

In the linear rotor type electric machinery, the rotor support 71 of the rotor portion 70 is located on the rail 62 of the stator portion 60. When an appropriate current is applied to each phase winding coil, a flux linkage induction is generated with the magnets 63 of the stator portion 60 of the permanent magnet electric machinery, such that the rotor portion 70 may linearly move on the stator portion 60.

The permanent magnet 63 disposed on the stator support 61 may be replaced by an electromagnet composed of a coil 64 and a magnetic element 65. Referring to FIG. 9, a schematic exploded view of the present invention forming the linear excitation electric machinery according to an embodiment of the present invention is shown.

Therefore, through the detailed description of the structural features, the technique content, and various embodiments, the design features of the present invention is clearly known as follows.

A winding module of permanent magnet electric machinery is provided. The winding module includes a base, an electric machinery winding having a plurality of winding coils formed on the base, and a sensing device having a plurality of sensing coils formed on the base. The electric machinery winding and the sensing coils are integrally formed on the base by using a technique for forming a printed circuit board, thereby improving the process yield rate and quality controllability, effectively reducing the volume of the electric machinery, thinning the structure, saving time and cost required for installing a position sensor, simplifying the process for fabricating the electric machinery, and preventing the position sensor from being affected by environment and temperature, so as to have a highly robust effect.

What is claimed is:

1. A winding module of permanent magnet electric machinery, comprising:
a base;
an electric machinery winding, having a plurality of winding coils formed on the base; and
a sensing device, having a plurality of sensing coils formed on the base, and arranged at intervals with the electric machinery winding.

2. The winding module of permanent magnet electric machinery according to claim 1, wherein the base comprises a printed circuit board.

3. The winding module of permanent magnet electric machinery according to claim 2, wherein the electric machinery winding and the sensing device are disposed on the same printed circuit board.

4. The winding module of permanent magnet electric machinery according to claim 1, wherein the base comprises a plurality of printed circuit boards.

5. The winding module of permanent magnet electric machinery according to claim 4, wherein the electric machinery winding and the sensing device are disposed on the different printed circuit boards.

6. The winding module of permanent magnet electric machinery according to claim 1, wherein the base, the electric machinery winding, and the sensing device form a stator portion of the permanent magnet electric machinery.

7. The winding module of permanent magnet electric machinery according to claim 1, wherein the base, the electric machinery winding, and the sensing device form a rotor portion of the permanent magnet electric machinery.

8. The winding module of permanent magnet electric machinery according to claim 6, wherein the permanent magnet electric machinery is an axial flux electric machinery.

9. The winding module of permanent magnet electric machinery according to claim 8, wherein the permanent magnet electric machinery is a rotating rotor type.

10. The winding module of permanent magnet electric machinery according to claim 8, wherein the permanent magnet electric machinery is a rotating rotor type sandwiched structure.

11. The winding module of permanent magnet electric machinery according to claim 8, wherein the permanent magnet electric machinery is a rotating rotor type multi-rotor structure.

12. The winding module of permanent magnet electric machinery according to claim 7, wherein the permanent magnet electric machinery is an axial flux electric machinery.

13. The winding module of permanent magnet electric machinery according to claim 12, wherein the permanent magnet electric machinery is a rotating rotor type.

14. The winding module of permanent magnet electric machinery according to claim 12, wherein the permanent magnet electric machinery is a rotating rotor type sandwiched structure.

15. The winding module of permanent magnet electric machinery according to claim 12, wherein the permanent magnet electric machinery is a rotating rotor type multi-rotor structure.

16. The winding module of permanent magnet electric machinery according to claim 7, wherein the base, the electric machinery winding, and the sensing device form the rotor portion of the permanent magnet electric machinery, and the permanent magnet electric machinery is a linear to and fro rotor type structure.

17. A winding module of an electric machinery, comprising:
a base;
an electric machinery winding, having a plurality of winding coils formed on the base; and
a sensing device, having at least one sensing coil formed on the base.

18. The winding module of permanent magnet electric machinery according to claim 17, wherein the base comprises a printed circuit board.

19. The winding module of permanent magnet electric machinery according to claim 18, wherein the electric machinery winding and the sensing device are disposed on the same printed circuit board.

20. The winding module of permanent magnet electric machinery according to claim 19, wherein the sensing coil is located in a distribution path of the winding coils.

21. The winding module of permanent magnet electric machinery according to claim 20, wherein the sensing coil is located on an intermediate region and a periphery of the winding coils, or is arranged at intervals with the winding coils.

22. The winding module of permanent magnet electric machinery according to claim 19, wherein the sensing coil is disposed beside a distribution path of the winding coils.

23. The winding module of permanent magnet electric machinery according to claim 17, wherein the base comprises a plurality of printed circuit boards.

24. The winding module of permanent magnet electric machinery according to claim 18, wherein the printed circuit board is a multi-layer printed circuit board.

25. The winding module of permanent magnet electric machinery according to claim 23, wherein the electric machinery winding and the sensing device are respectively disposed on different printed circuit boards.

26. The winding module of permanent magnet electric machinery according to claim 24, wherein the electric machinery winding and the sensing device are respectively disposed on different multi-layer printed circuit board.

27. The winding module of permanent magnet electric machinery according to claim 17, wherein the base, the electric machinery winding, and the sensing device form a stator portion of the electric machinery.

28. The winding module of permanent magnet electric machinery according to claim 17, wherein the base, the electric machinery winding, and the sensing device form a rotor portion of the electric machinery.

29. The winding module of permanent magnet electric machinery according to claim 27, wherein the electric machinery is a rotating rotor type.

30. The winding module of permanent magnet electric machinery according to claim 24, wherein the electric machinery is a rotating rotor type.

31. The winding module of permanent magnet electric machinery according to claim 24, wherein the electric machinery is a linear rotor type.
